(19) United States
(12) Patent Application Publication
(10) Pub. No.: US 2017/0324072 A1
(43) Pub. Date: Nov. 9, 2017

(54) Electrochemical Cell with Bipolar Faradaic Membrane

(71) Applicants: Massachusetts Institute of Technology, Cambridge, MA (US); Total Energies Nouvelles Activites USA, Courbevoie (FR); Total S.A., Courbevoie (FR)

(72) Inventors: Huayi Yin, Cambridge, MA (US); Fei Chen, Wuhan (CN); Brice Hoani Valentin Chung, Boston, MA (US); Takanari Ouchi, Brookline, MA (US); Donald Robert Sadoway, Cambridge, MA (US)

(21) Appl. No.: 15/661,367

(22) Filed: Jul. 27, 2017

Related U.S. Application Data
(63) Continuation-in-part of application No. 15/055,491, filed on Feb. 26, 2016.
(60) Provisional application No. 62/121,597, filed on Feb. 27, 2015.

(51) Int. Cl. H01M 2/16; H01M 4/38; H01M 10/0561; H01M 10/0525

(52) U.S. Cl. CPC H01M 2/1673; H01M 10/0561; H01M 10/0525; H01M 2/1613; H01M 2/1646; H01M 4/38

(57) ABSTRACT

An electrochemical cell comprising: a negative electrode comprising lithium and aluminum; a positive electrode, separate from the negative electrode, comprising a liquid phase having zinc; a liquid electrolyte, disposed between the negative electrode and the positive electrode, comprising a salt of lithium and a salt of zinc; and a bipolar faradaic membrane, disposed between the negative electrode and the positive electrode, having a first surface facing the negative electrode and a second surface facing the positive electrode, the bipolar faradaic membrane configured to allow cations of lithium to pass through and configured to impede cations of zinc from transferring from the positive electrode to the negative electrode, the bipolar faradaic membrane at least partially formed from a material having an electronic conductivity sufficient to drive faradaic reactions at the second surface with the cations of the positive electrode.

### CROSS-REFERENCE TO RELATED APPLICATIONS

This patent application is a continuation-in-part of U.S. patent application Ser. No. 15/055,491, filed Feb. 26, 2016, which claims the benefit of U.S. Provisional Patent Application No. 62/121,597 filed Feb. 27, 2015. The disclosures of all the foregoing applications are incorporated by reference herein in their entirety.

### TECHNICAL FIELD

The present invention relates to galvanic electrochemical cells for use in dynamic storage of energy, and more particularly to these galvanic cells operating at high currents.

### BACKGROUND

Electrical energy generation in the United States relies on a variety of energy sources such as fossil, nuclear, solar, wind and hydroelectric. With the concern of the dwindling supply of fossil fuel, one of the great challenges of energy supply chains is balancing supply with demand. In particular, managing the intrinsic intermittency of renewable sources of energy such as wind or solar is key to enable their adoption at large scale. Part of the problem is the inability to store electrical energy in an efficient and cost effective way. Electrochemical cells using liquid metals in alloying/dealloying reactions have been developed but generally operate at low voltages of about 1 volt or less. Enabling higher voltage cells while retaining the use of low cost materials would significantly decrease the cost of these devices and further improve their efficiency.

Ion selective membranes have been used as separators in electrochemical cell systems. For example, in a traditional zebra (Na/NiCl₂) battery, an ion selective Na⁺ conductive 13″-alumina ceramic membrane may be inserted between the electrodes to prevent the reaction of Na with the electrolyte as well as the irreversible back reaction of Ni²⁺ upon direct contact with the negative Na electrode. During charging, the solid Ni is oxidized to Ni²⁺ ion at the positive electrode while Na⁺ is reduced to liquid Na at the negative electrode. Ideally, an ion selective membrane should be as thin as possible so that its electrical resistance is as low as possible in order to allow maximum current to flow. However, a thin membrane is difficult to manufacture without pinholes, and a thin membrane lacks structural integrity and is subject to mechanical failure. Thus, these types of membranes have operational and manufacturing issues. For example, in the zebra (Na/NiCl₂) battery, the drawbacks of the β″-alumina ceramic membrane are (1) the membrane requires a complex manufacturing process that includes many steps, high temperature sintering and a controlled environment to achieve the intricacy of the β″ crystal structure; (2) the membrane is mechanically vulnerable and limits the lifetime of the battery, e.g., by failure under repeated thawing; (3) the thin ceramic membrane is fragile and increasingly vulnerable at larger scale; (4) the membrane requires minimal operating temperature, e.g., >200° C., to be practical because of its limited conductivity; and (5) the membrane is limited to Na⁺ itinerant ions.

### SUMMARY OF THE EMBODIMENTS

In a first set of representative embodiments, provided herein is an electrochemical cell comprising: a negative electrode comprising lithium and aluminum; a positive electrode, separate from the negative electrode, comprising a liquid phase having zinc; a liquid electrolyte, disposed between the negative electrode and the positive electrode, comprising a salt of lithium and a salt of zinc; and a bipolar faradaic membrane, disposed between the negative electrode and the positive electrode, having a first surface facing the negative electrode and a second surface facing the positive electrode, the bipolar faradaic membrane configured to allow cations of lithium to pass through and configured to impede cations of zinc from transferring from the positive electrode to the negative electrode, the bipolar faradaic membrane at least partially formed from a material having an electronic conductivity sufficient to drive faradaic reactions at the second surface with the cations of the positive electrode. The bipolar faradaic membrane may be configured to have the first surface positively charged and the second surface negatively charged. The positively charged first surface and the negatively charged second surface may be electrostatically induced. The electronic conductivity of the material of the membrane may be greater than or equal to 10⁻¹⁰ S/m at operating temperature of the electrochemical cell. The bipolar faradaic membrane may permeable to a passive spectator ion. The bipolar faradaic membrane may comprise a material selected from the group consisting of titanium nitride, zirconium nitride, titanium diboride, metals, metalloids, and combinations thereof. The bipolar faradaic membrane may further comprise a sintering additive, wherein the sintering additive may be selected from the group consisting of magnesium oxide, aluminum oxide, aluminum nitride, silicon nitride, silicon oxide, silicon oxynitride, and combinations thereof. The bipolar faradaic membrane may be an electronically conductive matrix comprising an insulator and conductive particles, wherein the insulator may be selected from the group consisting of magnesium oxide, aluminum oxide, silicon oxide, aluminum nitride, silicon nitride, silicon oxynitride, and/or polymers. The bipolar faradaic membrane may comprise a material selected from the group consisting of nickel-iron foam, copper foam, carbon foam, metal felt, metallic fibers, steels, alloys, and combinations thereof. The bipolar faradaic membrane may comprise a material selected from the group consisting of copper, titanium, iron, nickel, tungsten, tantalum, molybdenum, silicon, and combinations thereof. The bipolar faradaic membrane may further comprise an electronic pathway across the bipolar faradaic membrane, wherein the electronic pathway may comprise a material selected from the group consisting of iron, steel, and combinations thereof. The bipolar faradaic membrane may be a porous stainless steel membrane coated with titanium nitride. The positive electrode may further comprise a material selected from the group consisting of lead, tin, bismuth, antimony, aluminum, and combinations thereof. The bipolar faradaic membrane may be in direct contact with the negative electrode. The electrolyte may be between the negative electrode and the positive electrode, and on the side of the bipolar faradaic membrane facing the positive electrode. The negative electrode may be solid, partially solid, or liquid. The negative electrode may be more than 0 mol % and at most 50 mol % in lithium. The negative electrode may be contained in an electronically conductive container. The electrolyte may be selected from the group consisting of LiCl—KCl, LiBr—KBr, and LiCl—LiBr—KBr.

In a second set of representative embodiments, the present invention provides a method of exchanging electrical energy with an external circuit, the method comprising: connecting an external circuit to an electrochemical cell and operating the external circuit so as to drive transfer of electrons between the negative electrode and the positive electrode. The electrochemical cell comprises: a negative electrode comprising lithium and aluminum; a positive electrode, separate from the negative electrode, comprising a liquid phase having zinc; a liquid electrolyte, disposed between the negative electrode and the positive electrode, comprising a salt of lithium and a salt of zinc; and a bipolar faradaic membrane, disposed between the negative electrode and the positive electrode, having a first surface facing the negative electrode and a second surface facing the positive electrode, the bipolar faradaic membrane configured to allow cations of lithium to pass through and configured to impede cations of zinc from transferring from the positive electrode to the negative electrode, the bipolar faradaic membrane at least partially formed from a material having an electronic conductivity sufficient to drive faradaic reactions at the second surface with the cations of the positive electrode.

### BRIEF DESCRIPTION OF THE DRAWINGS

The foregoing features of embodiments will be more readily understood by reference to the following detailed description, taken with reference to the accompanying drawings, in which:

FIG. 1 is a vertical cross-sectional view showing an electrochemical cell with a bipolar faradaic membrane according to embodiments of the present invention.

FIG. 2 is a vertical cross-sectional view showing another configuration of an electrochemical cell with a bipolar faradaic membrane according to embodiments of the present invention.

FIGS. 3A-3C are vertical cross-sectional views illustrating the charging process of an electrochemical cell with a bipolar faradaic membrane, such as shown in FIG. 2, according to embodiments of the present invention. FIG. 3A shows when the cell is discharged, FIG. 3B shows when the cell is in operation and connected to a source of energy (charging circuit), and FIG. 3C shows when the cell is fully charged.

FIG. 4A is a graph of cell voltage as a function of time for a Li/LiCl—KCl/PbCl₂ displacement cell having a TiN-1-3 wt % MgO bipolar faradaic membrane operating at 450° C. according to embodiments of the present invention, and FIG. 4B is a graph of columbic efficiency and capacity as a function of cycle index for this cell comparing columbic efficiency, theoretical capacity, demonstrated capacity, and expected capacity without the bipolar faradaic membrane according to embodiments of the present invention.

FIG. 5 is a graph of cell voltage as a function of capacity for a Li—Pb/LiCl—KCl/PbCl₂ displacement cell having an electronically conductive titanium nitride bipolar faradaic membrane with 1-2 wt % MgO sintering additive operating at 410° C. according to embodiments of the present invention.

FIG. 6 is a graph of discharge capacity, energy efficiency and coulombic efficiency as a function of cycle number for a Li—Pb/LiCl—KCl/PbCl₂ cell having an electronically conductive titanium nitride bipolar faradaic membrane with 1-2 wt % MgO sintering additive operating at 405° C. and a charge current density of 200 mA/cm² and discharge current density of 100 mA/cm² according to embodiments of the present invention.

FIG. 7 is a graph of voltage and current as a function of time for a Li—Bi/LiCl—KCl/PbCl₂ cell having an electronically conductive titanium nitride bipolar faradaic membrane with 1-2 wt % MgO sintering additive operating at 405° C. according to embodiments of the present invention.

FIG. 8 is a graph of voltage as a function of capacity for a LiPb/LiCl—KCl/SnCl₂ cell having an electronically conductive titanium nitride bipolar faradaic membrane with 1-2 wt % MgO sintering additive operating at 400° C. at various current densities according to embodiments of the present invention.

FIG. 9 is a graph of voltage as a function of the mole % of tin for a Li—Sn/LiCl—KCl/SnCl₂ cell having an electronically conductive titanium nitride bipolar faradaic membrane with 1-2 wt % MgO sintering additive at various operating temperatures ranging from 370−405° C. according to embodiments of the present invention.

FIG. 10 is a graph of voltage as a function of capacity for a LiPb/LiBr-KBr/PbBr₂ cell having an electronically conductive titanium nitride bipolar faradaic membrane with 1-2 wt % MgO sintering additive operating at 370° C. according to embodiments of the present invention.

FIG. 11 is a graph of voltage as a function of capacity for a Mg—Pb/MgCl₂—NaCl—KCl/PbCl₂ cell having an electronically conductive titanium nitride bipolar faradaic membrane with 1-2 wt % MgO sintering additive operating at 420° C. according to embodiments of the present invention.

FIG. 12 is a graph of voltage as a function of capacity for a Mg—Sn/MgCl₂—NaCl—KCl/PbCl₂ cell having an electronically conductive titanium nitride bipolar faradaic membrane with 1-2 wt % MgO sintering additive operating at 420° C. according to embodiments of the present invention.

FIG. 13 is a graph of voltage as a function of time for a Li—Al/LiCl—KCl/Zn cell having an electronically conductive stainless steel bipolar faradaic membrane operating at 440° C. according to embodiments of the present invention.

FIG. 14 is a graph of discharge capacity, energy efficiency and coulombic efficiency as a function of cycle number for the cell of FIG. 13.

### DETAILED DESCRIPTION OF SPECIFIC EMBODIMENTS

As used in this description and the accompanying claims, the following terms shall have the meanings indicated, unless the context otherwise requires:

References to the state of a component of an electrochemical cell are intended as characterizing the component at a temperature of operation of the cell. For instance, a “molten salt electrolyte” is to be understood as being in the molten state when the cell is in operation, but may be solid at colder temperatures when the cell is inactive.

When a component of an electrochemical cell is characterized as containing a chemical element, such characterization is to be understood as referring to the element and compounds thereof, such as alloys and salts. For example, an electrode characterized as containing zinc (Zn) may contain elemental Zn and/or its salts such as ZnCl₂.

Embodiments of the present invention include displacement salt reaction liquid metal electrochemical cells having a bipolar faradaic membrane. The displacement cell is described in U.S. Pat. Appl. Publ. No. 2014/0272481, which is incorporated by reference herein in its entirety. The electrochemical cell configuration with the bipolar faradaic membrane facilitates electrochemical cell faradaic reactions, which represents a notable departure from using ionically conductive separators that just passively inhibit passage of all but one type of ion. The bipolar faradaic membrane is disposed between the positive and negative electrodes, is electronically conductive, and prevents irreversible back reaction. The bipolar faradaic membrane does not operate as an ion-selective membrane, but rather as a porous bipolar electrode having, in one embodiment, one electrostatically induced positively charged surface and one electrostatically induced negatively charged surface. The charged surfaces drive spontaneous protective charge transfer reactions. The bipolar faradaic membrane has a sufficient conductive pathway available to electrons between the top and bottom surfaces of the bipolar faradaic membrane to drive faradaic reactions at the bottom surface with the cations of the positive electrode and thus allow the protective charge transfer reaction to occur.

In addition, a porous material may be used in the bipolar faradaic membrane design in order to slow down diffusion of positive salt cations while still allowing electrolytic contact of the itinerant ion (i.e., the negative electrode cation) and salt anion. The electrolytic contact may be established in the pores of the bipolar faradaic membrane, and the pores may be selected so that certain smaller ions are allowed to pass through the pores, while larger ions are inhibited from passing through.

For example, in the case of a Li/LiCl—KCl/Pb cell, on one surface of the bipolar faradaic membrane, Li metal dissolved in the electrolyte can be oxidized back to Li⁺ (LiCl). The released electron can short through the conductive bipolar faradaic membrane and combine with Pb²⁺ (PbCl₂) at the other surface of the bipolar faradaic membrane to form liquid Pb, which drops back to the Pb positive electrode. Therefore, the bipolar faradaic membrane functions as a dynamic ion selector permeable to the negative electrode ion (in this example Li⁺) and salt anion (in this example Cl⁻) while impeding the positive salt cation (in this example Pb²⁺). Although the bipolar reaction occurs at the expense of a decrease in cell voltage, the attendant suppression of irreversible capacity fade enables the cell to operate for a long service lifetime (many years) while maximizing round-trip efficiency. Details of illustrative embodiments are discussed below.

As used herein, the term “battery” may encompass individual electrochemical cells or cell units having a positive electrode, a negative electrode, and an electrolyte, as well as configurations having an array of electrochemical cells.

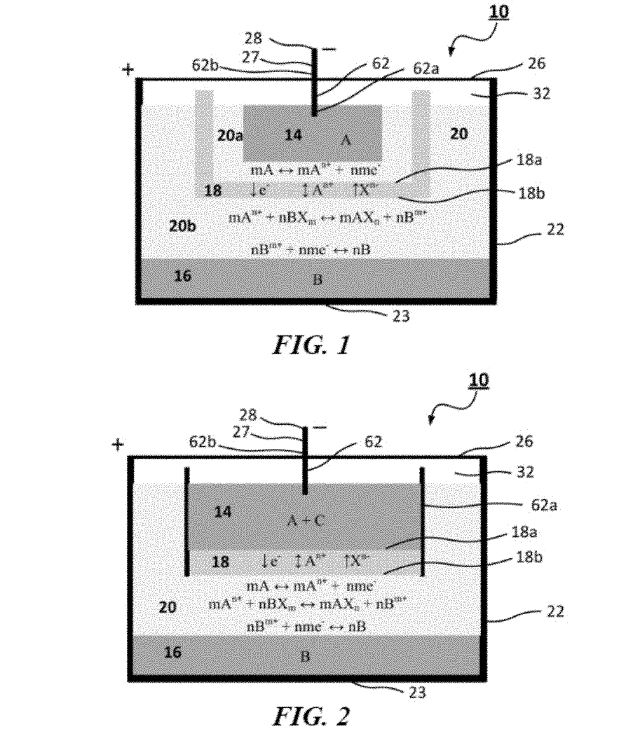

FIGS. 1 and 2 show an electrochemical cell or battery 10, according to embodiments of the present invention, having an electronically conductive layer or negative electrode 14 with an active metal A and an electronically conductive layer or positive electrode 16 with a metallic or metalloid element or alloy B. These electrodes 14, 16 cooperate to efficiently store and deliver energy across an ionically conductive layer or electrolyte 20 (e.g., shown as 20a and 20b in FIG. 1). In embodiments of the present invention, the stored energy relies on the difference of a thermodynamically unfavorable displacement of an anodic salt AXn (e.g., LiCl) by a cathodic salt BXm (e.g., PbCl₂) in the electrolyte 20, such as described in U.S. Pat. Appl. Publ. No. 2014/0272481.

The anode or negative electrode 14 metal A, preferably weakly electronegative, tends to form stronger ionic bonds with anions, e.g., like halides. The anode metal may include alloys or elements of the alkali and alkaline earth metals (e.g., Li, Na, Ca, Mg, Sr, Ba) although stronger electronegative metals, such as Pb, Bi, Sn, Zn, Sb, Hg and alloys thereof (e.g., SbPb, LiPb, MgPb, MgSn, LiSn, LiBi) may also be used. The cathode or positive electrode 16 metal B may be selected among strongly electronegative metals, metalloids or transition metals (e.g., Pb, Sb, Bi, Sn, Al, Fe, Ni, Cu, Cr, Zn, and alloys thereof), which tend to form weaker bonds with anions, e.g., like halides and others. The electrolyte 20 may include a mixture of halide salts appropriately formulated so as to form a low melting liquid electrolyte 20. For example, the electrolyte 20 may be a eutectic mixture of halides, for example chlorides, or bromides or both, e.g., LiCl—KCl, LiBr—KBr, LiCl—LiBr—KBr. In addition to the principal constituents of the salt, additives such as iodide and sulfide may be added into the electrolyte 20 to improve the cell 10 performance. At the operating temperature of the electrochemical cell 10, the negative and positive electrodes 14, 16 are all-liquid phase or a combination of liquid and solid phases during operation, and the electrolyte 20 is liquid phase during operation.

The electrochemical cell 10 further includes a bipolar faradaic membrane 18 disposed between the negative electrode 14 and positive electrode 16 having a first surface 18a that faces the negative electrode 14 and a second surface 18b that faces the positive electrode 16. In some embodiments, the first surface 18a is positively charged and the second surface 18b is negatively charged. The charged surfaces 18a, 18b may be electrostatically induced by the upper and lower electrodes 14, 16. The bipolar faradaic membrane 18 separates the electrolyte contacting the positive electrode 16 from the negative electrode 14. In the FIG. 1 configuration, the bipolar faradaic membrane 18 is disposed within the electrolyte 20, so that electrolyte 20a is between the negative electrode 14 and the bipolar faradaic membrane 18 and electrolyte 20b is between the bipolar faradaic membrane 18 and the positive electrode 16. In the FIG. 2 configuration, the negative electrode 14 includes an alloy (designated A+C) and the bipolar faradaic membrane 18 is in direct contact with the negative electrode 14. In both cases, the bipolar faradaic membrane 18 is porous and functions as a dynamic ion selector, allowing the smaller cations, Aⁿ⁺, of metal A, the first active metal, to pass through the bipolar faradaic membrane 18 along with the electrolyte anion and any spectator anions, and impeding cations, B^{m+}, of metal B, the second active metal, from coming in contact with the negative electrode 14. For example, in the FIG. 1 configuration, the pore size may be, e.g., greater than or equal to about 0.5 nm and preferably less than or equal to about the size of the cation of the positive electrode 16. In the FIG. 2 configuration, the pore size may be, e.g., greater than or equal to about 0.5 nm and preferably less than the size of metal A in the negative electrode 14 so as to prevent the metal A from entering the pores of the bipolar faradaic membrane 18. The bipolar faradaic membrane 18 is at least partially formed from a material having an electronic conductivity sufficient to drive the faradaic reactions at the lower surface 18b of the bipolar faradaic membrane 18. For example, the electronic conductivity may be greater than or equal to about 10⁻¹⁰ S/m at the operating temperature of the electrochemical cell. The combination of electronic conductivity of the bipolar faradaic membrane 18 body and its porosity to cations of the negative electrode 14 should outpace the arrival of cations of the positive electrode 16 to the lower surface 18b of the bipolar faradaic membrane 18 so that the faradaic reactions at the lower surface 18b of the bipolar faradaic membrane 18 allow sufficient protective charge transfer reactions to occur.

For example, in a Li/PbCl₂ cell configuration such as shown in FIG. 1, the bipolar faradaic membrane 18 allows the transfer of ions, such as Li⁺ and through the bipolar faradaic membrane 18 while effectively blocking the larger PbCl₄²⁻ (complexed Pb²⁺ ions) to the negative electrode 14 chamber by concurrent processes of oxidation of solvated Li at the top 18a of the bipolar faradaic membrane 18, electron conduction through the bipolar faradaic membrane 18, and reduction of Pb²⁺ ions at the bottom 18b of the bipolar faradaic membrane 18. Specifically, the Li metal dissolved in the electrolyte 20 oxidizes back to Li⁺ (LiCl) in a faradaic reaction on the upper surface 18a of the bipolar faradaic membrane 18 towards the negative electrode 14. The released electron shorts through the bipolar faradaic membrane 18 and combines with Pb²⁺ (PbCl₂) at the lower surface 18b in a faradaic reaction to form liquid Pb. The reduced liquid Pb at the bottom 18b of the bipolar faradaic membrane 18 then drops back to the positive electrode 16 Pb pool, enabling a sustainable protection process. To prevent Pb²⁺ cross-over to the negative electrode 14 chamber, the rate of solvated Li reaching the top 18a of bipolar faradaic membrane 18 should equal or exceed the Pb²⁺ rate reaching the bottom 18b of the bipolar faradaic membrane 18. The electrochemical cells 10 are designed to operate such that the protective charge transfer reaction is not rate limited by the transport of solvated Li but rather limited by the transport of Pb²⁺.

To address this issue, the bipolar faradaic membrane 18 may be disposed directly adjacent to the negative electrode 14, such as shown in FIG. 2. For example, in a LiPb/PbCl₂ cell configuration such as shown in FIG. 2, the reduction of Pb²⁺ to Pb metal in a faradaic reaction at the bottom of the bipolar faradaic membrane 18 occurs with the corresponding oxidation of Li (in the LiPb alloy in the negative electrode 14) to Li⁺ ion in a faradaic reaction at the top 18a of the bipolar faradaic membrane 18. By allowing the negative electrode 14 to directly contact the bipolar faradaic membrane 18, the LiPb negative electrode 14 provides a superabundance of negative Li reductant to supply electrons to the bottom surface 18b of the bipolar faradaic membrane 18 at a rate only as required by the arrival of Pb²⁺. The process can be viewed as an indirect metallothermic reduction consisting of two half reactions of Li oxidation from Li-alloys (on one surface 18a of the bipolar faradaic membrane 18), and Pb²⁺ reduction to Pb metal by electron transfer through the bipolar faradaic membrane 18 (on the opposite side 18b of the bipolar faradaic membrane 18). Although the redox reaction somewhat sacrifices the charged capacity of the cell 10, the reduced liquid Pb at the bottom 18b of the bipolar faradaic membrane 18 drops back to the positive electrode 16 Pb pool at which point the Pb once again becomes available for charge (reversible protection process). Furthermore, by reducing the solubility and diffusivity of Pb²⁺, round-trip efficiency can be maximized as demonstrated in the Examples shown below.

The advantages of embodiments of the electrochemical cell 10 with the bipolar faradaic membrane 18 shown in FIG. 2 include the fact that the rate of protective charge transfer is not limited by the dissolution rate of the negative electrode 14 or the transport of the dissolved metal to the upper surface of the bipolar faradaic membrane. Additionally, in such embodiments the reactivity of A is reduced by alloying with metal C, e.g., Pb, Sn, Bi, reducing the activity of A in the negative electrode 14, which lowers the corrosion against secondary cell components from A. This results in a wider range of materials suitable for seal materials. There is no need for an electrolyte 20 in the negative electrode 14 chamber, which saves on material costs and enhances volumetric utilization. In addition, this configuration yields a broader selection of materials for the negative electrode 14 chamber and the bipolar faradaic membrane 18 by having the alloying negative electrode 14 act as a sacrificial anode against potential Pb²⁺ corrosion. Alternative chemistries may be used because all cations with a lower displacement potential than that of Li in the Li—Pb alloy may be effectively blocked. For example, for an electrochemical cell 10 having a LiPb negative electrode 14, a non-exhaustive list includes Pb²⁺, Bi³⁺, Zn²⁺, Sn²⁺, Al³⁺ ions that can be reduced to their corresponding metal by the Li—Pb alloy.

The bipolar faradaic membrane 18 may include a collection of conductive particles that, at operating temperature, self-settle by density to form a malleable porous layer, e.g., TiN, ZrN, TiB₂, graphite, graphene, carbon nanotubes, metals (e.g., Cu, Ti, Fe, Ni, W, Ta, Mo, Si). The bipolar faradaic membrane 18 may include a sintered collection of particles that form a solid porous structure, e.g., TiN, ZrN, TiB₂, graphite, metals (e.g., Cu, Ti, Fe, Ni, W, Ta, Mo) plus sintering additives (e.g., MgO, AlN, SiN, Al₂O₃, SiO₂). The bipolar faradaic membrane 18 may include a composite matrix of insulating (e.g., MgO, Al₂O₃, SiO₄ AlN, Si₃N₄) and conductive particles. For operation at sufficiently low temperature, the insulator could include polymeric materials. The bipolar faradaic membrane 18 may include a porous metallic structure, such as Ni—Fe foam, copper foam, carbon foam, metal felts, perforated material, metallic fibers (e.g., Cu, Ti, Fe, Ni, W, Ta, Mo), steels or alloys thereof. The bipolar faradaic membrane 18 may include a composite architecture of porous media with a distinct conductive upper and lower surface and electronic pathway across the bipolar faradaic membrane 18, e.g., MgO, BN, AlN, SiN, with the electronic pathway made of, e.g., Fe, steel, graphite.

The range of metal available makes for a mechanically robust bipolar faradaic membrane 18 especially when compared to the prior art thin ceramics, like beta-alumina. The bipolar faradaic membrane 18 is an inexpensive and simple to manufacture component, mechanically robust, scalable, functional at any temperature, and operative with any itinerant ion (e.g., Na, Li, Mg, Ca).

The bipolar faradaic membrane 18 may be configured to balance the solubility/rate of diffusion of the positive salt ions, the ionic conductivity through the bipolar faradaic membrane's pores and the solubility/rate of diffusion of the negative electrode ions in the electrolyte 20. For example, the physical properties (e.g., thickness, electronic conductance, effective porosity) and the materials used for the bipolar faradaic membrane 18 may be tailored for a particular cell chemistry, cell configuration, and cell operating conditions to achieve the desired balance.

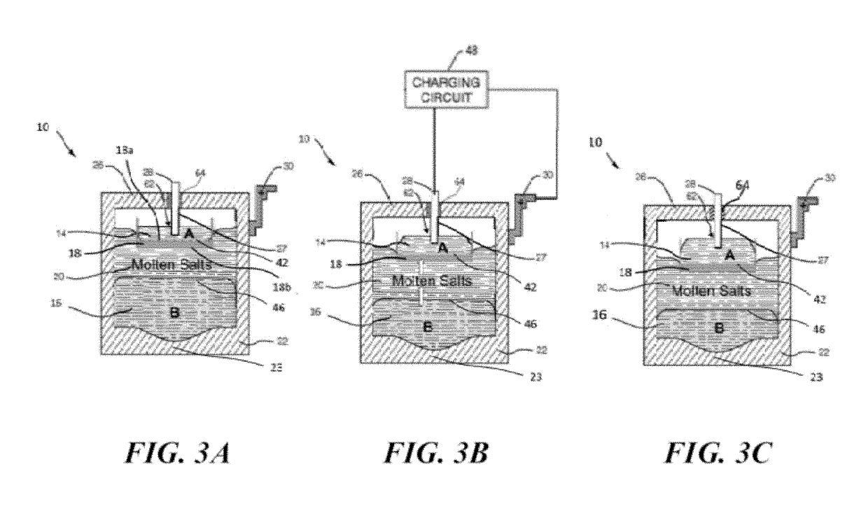

Referring again to FIGS. 1 and 2, the negative electrode 14, positive electrode 16, electrolyte 20 (both 20a and 20b), and bipolar faradaic membrane 18 are confined in a container 22, which preferably includes a lid 26. The cell container 22 and lid 26 may be made of a conductive material (e.g., mild steel, stainless steel, graphite) or a conductive material coated with a thin ceramic (e.g., oxide, nitride, carbide). An electronically conductive structure 62 may be suspended from the lid 26 of the container 22 and may serve as a negative current collector 27. The lid 26 confines the molten constituents and vapors within the container 22. An electrically insulating seal 64 (shown in FIGS. 3A-3C), e.g., made of boron nitride, alumina, magnesia, and aluminum nitride, may electrically isolate the conductive structure 62 from the lid 26. The container 22 and lid 26 may be formed from materials having the requisite electrical conductivity (when so required), mechanical strength, and resistance to chemical attack by the materials that form the electrodes 14 and 16 and electrolyte 20.

One portion 62a of the structure 62 may hold the negative electrode 14 away from the walls of the container 22, obviating the need for an insulating sheath along the walls, and another portion 62b of the structure 62 may extend outside of the lid 26 and serve as the negative terminal 28. The portion 62a that holds the negative electrode 14 may be in the shape of one or more rods (as shown in FIG. 1), an inverted cup, a tube (as shown in FIG. 2) or a mesh. The mesh may be composed of strands on the order of 0.1 to 1 mm in diameter, with similar spacing, although other dimensions may also be used.

Alternatively, or in addition, the portion 62a that holds the negative electrode 14 may be a porous material, e.g., foam or sponge, which holds the negative electrode within the porous material. The porous container may be able to suspend the liquid metal negative electrode 14 without permeation of the metal. The porosity allows electrolyte 20 contact and hence itinerant ion (e.g. Li⁺) and salt anion (e.g. Cl⁻) conductivity. The porous container is preferentially wetted by the molten salt electrolyte 20. The conductive bipolar faradaic membrane 18 composition and porosity are tailored in such a way that the alloy anode 14 is not soaked into the bipolar faradaic membrane 18 while still maintaining direct contact.

Depending on the composition of the negative electrode 14, the structure 62 may be made of, e.g., iron or its alloys, carbon or its alloys, such as graphite, mild steel, or a steel alloy containing, for example, nickel and/or chromium. For example, the negative current collector 27 may include a conductive porous foam or mesh 62a (not shown), e.g., iron, iron alloys, connected to a rod 62b. The electronically conductive structure 62 is preferably configured so that some of the liquid or partially liquid negative electrode 14 remains between or within the portion 62a during the charge and discharge cycles, as discussed in more detail below. Surface tension may maintain the negative electrode 14 in place around the portion 62a of the electronically conductive structure 62, such as shown in FIG. 1, or the negative electrode 14 may be held within the portion 62a of the electronically conductive structure 62, such as shown in FIG. 2.

A portion of the container 22 in contact with the positive electrode 16 functions as a positive current collector 23, through which electrons may pass to an external source or load by way of a positive terminal (discussed in FIGS. 3A-3C below) connected to the container 22. The negative terminal 28 and the positive terminal may be oriented to facilitate arranging individual cell units in series by connecting the negative terminal 28 of one cell unit to the positive terminal of another cell unit 10 to form a battery or electrochemical cell. Alternatively, the negative terminals 28 may be connected to one another, and the positive terminals may be connected to one another to arrange the cells in parallel.

Alternatively, the interior surface of the container 22 may include an insulating inner sheath (not shown). The sheath may prevent shorting by electronic conduction between the negative electrode 14 and the positive electrode 16 through the container 22 when the container is made of electronically conductive material and an electronically conductive structure 62 is not used to hold the negative electrode 14 away from the walls of the container 22. The sheath may be formed from an electrically insulating material and should be corrosion-resistant against the electrodes 14 and 16 and the electrolyte 20. For example, boron nitride, aluminum nitride, alumina, and/or magnesia are appropriate materials for the sheath and seal 64 (shown in FIGS. 3A-3C), although other materials, such as high temperature resistant polymers, like poly(oxyethylene) methacrylate-g-poly(dimethyl siloxane) (POEM-g-PDMS), also may be used.

The electrochemical cell 10 also may have an inert gas layer 32 overlaying the negative electrode 14 and the portion 62a of the electrically conductive structure 62 in order to accommodate global volume changes in the cell system produced by charging and discharging, or temperature changes. Optionally, the lid 26 or seal 64 may incorporate a safety pressure valve (not shown) in order to regulate changes in pressure within the electrochemical cell 10.

During operation of the electrochemical cell 10 shown in FIG. 2, the ratio of active metal cations in the electrolyte 20 varies. The composition of the electrolyte 20 changes from one where the first active metal salt AXₙ is predominant (discharged state) to a composition where the second active metal salt BXₘ is predominant (charged state). Changes in the salt composition of the electrolyte 20 are controlled by the following reactions occurring simultaneously at the electrode-bipolar faradaic membrane interface 42 and the electrode-electrolyte interface 46:

Anode/bipolar faradaic membrane: mA [symbol] m(Aⁿ⁺+ne⁻)

Electrolyte/catholyte: mAⁿ⁺+n(BXₘ) [symbol] m (AXₙ)+nB^{m+}

Catholyte/cathode: n(B^{m+}+me⁻) [symbol] nB

Numerous factors are important when choosing additional elements for the electrodes 14, 16. For example, those factors include, among other things, the chemical equilibrium and solution thermodynamics in the electrodes, their interactions with the electrolyte, their relative densities, melting points and boiling points.

The illustrative electrochemical cell 10 receives or delivers energy by transporting metals, such as the first active metal from the anode 14 into the electrolyte 20 and the second active metal from the electrolyte 20 into the cathode 16 upon charging and vice versa upon discharging. The liquid electrolyte 20, comprising cations of both active metals, enables ionic transport of the active metals from the electrodes 14, 16 into the electrolyte 20 and vice versa. The bipolar faradaic membrane 18 prevents the cation of the second active metal from contacting the first active metal electrode 14.

FIGS. 3A-3C show the charging process for the electrochemical cell 10, such as shown in FIG. 2, according to embodiments of the present invention. FIG. 3A shows the cell 10 in an uncharged or discharged state. The positive electrode 16 may be in a liquid phase, such as shown in FIG. 3A, or may include liquid and solid phases. Before charging, the electrolyte 20 contains cations of the active anodic metal Aⁿ⁺ or of both the active metals Aⁿ⁺ and B^{m+} (e.g., a molar amount of the cations of the first active metal Aⁿ⁺ may be greater than the molar amount of the cations of the second active metal B^{m+}). For example, the parts of these cations as expressed by Aⁿ⁺: B^{m+} may initially be from about 1:1 to about 1:100. The bipolar faradaic membrane 18 meets the electrolyte 20 at the negative electrode/bipolar faradaic membrane interface 42. In a corresponding manner, the positive electrode 16 meets the electrolyte 20 at a separate positive electrode/electrolyte interface 46. As shown and discussed below, these interfaces move during charging and discharging, and the volumes of the negative electrode 14 and positive electrode 16 increase or decrease at the expense of one another.

Specifically, FIG. 3B shows the effect of the charging process on the components of the electrochemical cell 10. To initiate charging, the terminals 28 and 30 are connected to an external charging circuit 48, which drives the active metal salt Aⁿ⁺, which is converted into the active metal A at the negative electrode/bipolar faradaic membrane interface 42. The active cations and the electrons meet at the interface 42 and are consumed in the reduction half-cell reaction mAn⁺+mne⁻→mA. During charging, electron current travels from the external circuit, through the negative current collector 27, into the negative electrode 14, and to the negative electrode/bipolar faradaic membrane interface 42. The neutral active metal atoms A created in the half-cell reaction accrue to the negative electrode 14. As the active metal A accumulates in the negative electrode 14, the negative electrode/bipolar faradaic membrane interface 42 moves further away from the negative current collector 27 as the negative electrode 14 grows thicker. Meanwhile, the active metal B is driven from the positive electrode 16, into the electrolyte 20, as a cation B^{m+} at the positive electrode/electrolyte interface 46. At the positive electrode/electrolyte interface 46, atoms of the active metal B in the positive electrode 16 are oxidized in the half-cell reaction nB→nB^{m+}+nme⁻. As active cations B^{m+} enter the electrolyte 20, electrons are freed to pass through the positive current collector 23 to the external charging circuit 48. Oxidation of the active metal atoms B shrinks the positive electrode 16, and the electrolyte interface 46 moves toward the positive current collector 23.

The active metal deposited in the negative electrode 14 represents stored electrical energy which may persist substantially indefinitely, as long as no external electrical path joins the two electrodes 14 and 16 and the recombination of cathodic salt at the negative electrode/bipolar faradaic membrane interface 42 is minimized.

FIG. 3C shows the cell 10 in its final charged state. Charging has changed the composition of at least the electrolyte 20, by loss of atoms of the first active metal salt Aⁿ⁺, and increase of the second active metal salt B^{m+}. The thickness of the negative electrode 14 has grown at the expense of the positive electrode 16. The electrolyte layer 20 may have changed in volume due to a difference in density between the first and second active metal salts.

The discharge process for the electrochemical cell 10 shown in FIG. 2 is the same as the charging process, but in reverse (e.g., shown by FIGS. 3C through 3A) with FIG. 3B having a load, rather than a power supply, attached to the terminals 28 and 30. The charging process of the electrochemical cell 10 shown in FIG. 1 operates in a similar manner as described in FIGS. 3A-3C except that the active cations Aⁿ⁺ and the electrons meet at the interface of the negative electrode 14 and electrolyte 20a and are converted into the active metal A at that interface.

Although the above discussion mentions the top and bottom surfaces or the upper and lower surfaces, embodiments of the electrochemical cell 10 may be formed in any orientation, e.g., with the negative electrode 14 on the top and the positive electrode 16 on the bottom (as shown in FIGS. 1 through 3C), with the negative electrode 14 on the bottom and the positive electrode 16 on the top, or with the negative electrode 14 and positive electrode 16 oriented in a side-by-side configuration. In addition, the bipolar faradaic membrane 18 may be configured to have either surface positively or negatively charged, as long as the positively charged surface is facing the negative electrode 14 and the negatively charged surface is facing the positive electrode 16 so that the electrostatically induced charges drive spontaneous protective charge transfer reactions. Although the above discussion discloses one positive electrode and one negative electrode, one or more positive electrodes 16 and/or one or more negative electrodes 14 may be used.

The compositions of the electrode 14 and 16 and electrolyte 20 may be formulated so that all-liquid operation may be reached at relatively low temperatures, such as about 500° C. or lower, e.g., between about 200° C. to 300° C. Difficulties such as volatilization of cell constituents, structural weakness, chemical attack of ancillary materials, and power required to maintain liquidity of the electrodes 14 and 16 and electrolyte 20 become more manageable as the operating temperature decreases, reducing the cost of operating the cell 10 and extending its service lifetime.

The electrodes 14 and 16 and the electrolyte 20 may be further formulated so that their densities are ordered in accordance with their functions in the electrochemical cell 10. Various embodiments having respective densities increasing or decreasing in the order of negative electrode 14/electrolyte 20/positive electrode 16 may spontaneously self-assemble into the illustrated vertically stacked, layered structure upon melting, providing for simpler manufacture.

The bipolar faradaic membrane 18 allows a manufacturing-focused, cell 10 to be made with demonstrated performance that projects to a full system cost <100$/kWh (cell active material, secondary material, system components and manufacturing process) and a cycle lifetime of a minimum of 10,000 cycles. The embodiments of the electrochemical cell 10 described herein may be used in electrolytic metallurgy, electro refining, metal extraction, and electrochemical filtration.

The electrochemical cell or battery 10 may be capable of rapidly receiving and dispatching electricity, thus bridging a supply-demand mismatch. The electrochemical cells 10 may operate at extreme temperatures, such as arctic cold and desert heat, without restriction on geographical location, and are realizable in a mobile application.

Embodiments of the electrochemical cells 10 thus may achieve high capability while using low-cost, abundant materials. Selection of the first and second active metals, bipolar faradaic membrane 18, and electrolyte 20 in various combinations discussed herein, permits a self-assembling cell and enables low-cost manufacturing.

Li—Al Cells

In some embodiments, the composition of the electrodes 14 and 16 and electrolyte 20 may be formulated so that a solid or partially solid phase is present at the negative electrode at a temperature of operation of the cell or battery 10. In some embodiments, an alloy including lithium and aluminum, herein referred to as “Li—Al,” may provide a solid or at least partially solid negative electrode 14. Other configurations are also contemplated where the negative electrode is a liquid formulation, for instance a Li—Al—Mg alloy.

It has been found that, in spite of the negative electrode 14 being in the solid phase, the performance of the Li—Al cell remains very stable and does not degrade at high cycle counts. As Li—Al exhibits higher redox potentials than Li—Pb alloys, the positive electrode 16 may include one or more of Zn and its compounds, where Zn is oxidized to Zn²⁺ during charging of the battery. The resulting displacement cells, such as Li—Al/LiCl—KCl/ZnCl₂, where the positive electrode 16 features a liquid phase containing Zn, can attain the voltages in the same ranges as Li—Pb/LiCl—KCl/PbCl₂ cells.

Since Al and Zn are non-toxic, lower cost, lighter in weight, and provide similar voltages compared to some of the exemplary displacement cells described herein that use materials such as Pb, Bi, and Sn, this displacement cell may be attractive for commercialization due to its lower cost, higher specific energy density, and environmentally friendly features.

Thus, the negative electrode of the Li—Al cell includes aluminum, the positive electrode includes zinc, and an electrolyte including a salt of lithium is disposed between the negative electrode and the positive electrode. The bipolar faradaic membrane, disposed between the negative electrode and the positive electrode, has a first surface facing the negative electrode and a second surface facing the positive electrode. The bipolar faradaic membrane is configured to allow cations of lithium to pass through and configured to impede cations of zinc from transferring from the second surface to the first surface, and is at least partially formed from a material having an electronic conductivity sufficient to drive faradaic reactions at the second surface with the cations of the positive electrode. Prior to charging, the negative electrode may be made of pure aluminum or may also already include lithium in the form of a Li—Al alloy. When the cell undergoes charging, lithium ions from the electrolyte are reduced to atomic lithium which is incorporated in the Li—Al alloy of the negative electrode, while the Zn of the positive electrode is oxidized to Zn²⁺ and can combine with salt anions in the electrolyte (e.g., Cl⁻ or Br⁻) to form a cathodic salt of Zn on the side of the membrane facing the positive electrode.

In representative embodiments, the negative electrode 14 may have a Li molar concentration of more than 0 mol % to at most 50 mol %, depending on the state of charge of the battery 10. Subject to compatibility with the chemistry of the Li—Al cell, one or more of the materials listed above in paragraph [0029] may also be included in the cathode or anode of the Li—Al cell. For example, in addition to Li, the anode 14 may include elements of the alkali and alkaline earth metals (e.g., Na, K, Cs, Ca, Mg, Sr, Ba). In some embodiments, the negative electrode may 14 include, in addition to Al, one or more of stronger electronegative metals, for example Pb, Bi, Sn, Sb, and Hg. In addition to Zn, the positive electrode 16 may further include other materials such as Pb, Sb, Bi, Sb, Hg, Ga, In, and their compounds.

Also as anticipated above in paragraph [0029], the electrolyte 20 may include a low melting mixture of halide salts, for example chlorides, or bromides or both, e.g., LiCl—KCl, LiBr—KBr, LiCl—LiBr—KBr. In representative embodiments, the electrolyte is between the negative electrode and the positive electrode, and on the side of the bipolar faradaic membrane facing the positive electrode.

The bipolar faradaic membrane 18 functions as a dynamic ion selector permeable to the negative electrode ion (such as Li⁺) and salt anion (for example Cl⁻) while impeding the positive salt cation(s) (in this instance Zn²⁺ and optionally other metals). To operate such that the protective charge transfer reaction is rate-unlimited by the solvated Li reaching rate and limited by the Zn²⁺ reaching rate, the bipolar faradaic membrane 18 may be disposed directly adjacent to the negative electrode, e.g., in a configuration analogous to that adopted above for instances where the positive salt cation is Pb²⁺. Alternative chemistries may be used because all cations with a lower displacement potential than that of Li in the Li—Al alloy may be effectively blocked.

In some embodiments, the bipolar faradaic membrane is configured to have its first surface positively charged and the second surface negatively charged. The positively charged first surface and the negatively charged second surface may be electrostatically induced. The electronic conductivity of the material of the membrane may be greater than or equal to 10⁻¹⁰ S/m at operating temperature of the electrochemical cell. The electrochemical cell may be to one or more passive spectator ions.

In some embodiments, the bipolar faradaic membrane 18 is made of a material that is stable in the presence of Li—Al, for instance titanium nitride, zirconium nitride, titanium diboride, metals, and metalloids. Non-limiting example bipolar faradaic membrane materials include nickel-iron foam, copper foam, metal felt, metallic fibers, steels, alloys, copper, titanium, iron, nickel, tungsten, tantalum, molybdenum, and silicon. Additionally, the membrane 18 may include a sintering additive, such as magnesium oxide, aluminum oxide, aluminum nitride, silicon nitride, silicon oxide, and silicon oxynitride. In some embodiments, the bipolar faradaic membrane 18 is an electronically conductive matrix comprising an insulator and conductive particles, where the insulator may be, for instance, magnesium oxide, aluminum oxide, silicon oxide, aluminum nitride, silicon nitride, silicon oxynitride, and/or one or more polymers. In another set of representative embodiments, the membrane 18 may feature a pathway for conducting electrons. The electronic pathway may include an electrically conductive material, for example iron or steel. In an exemplary embodiment, the bipolar faradaic membrane is a porous stainless steel membrane coated with titanium nitride.

### EXAMPLES

### Example 1

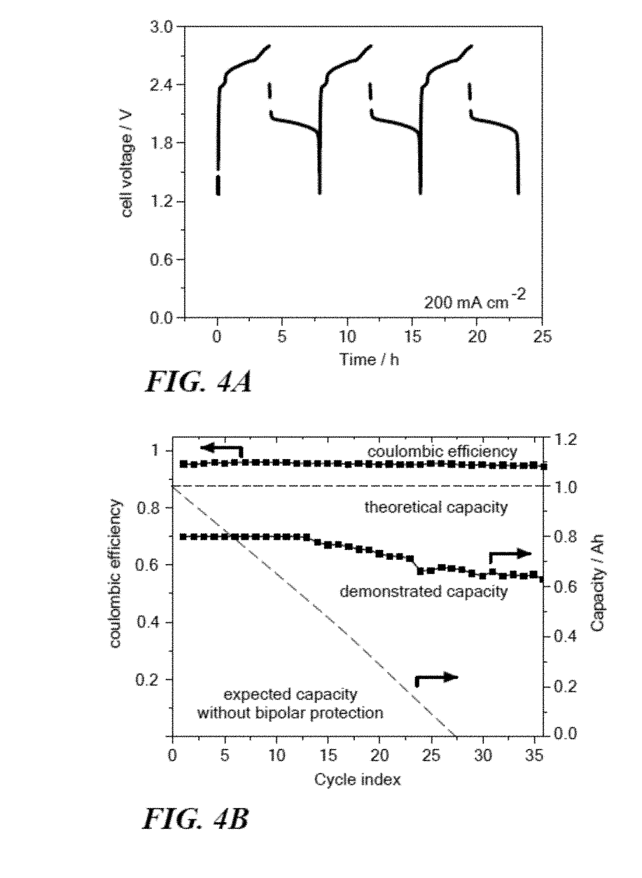

A Li/LiCl—KCl/PbCl₂ displacement cell was assembled with Li as the negative electrode, Pb as the positive electrode, and LiCl—KCl as the electrolyte. The cell included a bipolar porous faradaic membrane, such as shown in FIG. 1. The bipolar faradaic membrane was composed of electronically conductive titanium nitride with 1-2 wt % MgO sintering additive, having a thickness of 3-5 mm. The powdered mixture was sintered at 1100° C. overnight in a graphite crucible that had communication holes in the bottom (about 10 microns in diameter) to allow electrolyte salt permeation. As shown in FIG. 4A, 30 charge/discharge cycles at an operating temperature of 450° C. and a high current density of 200 mA/cm² consistently achieved 70% energy efficiency. FIG. 4B shows the corresponding discharge capacity as a function of cycle index. A cell without the bipolar faradaic membrane protection suffers from limited coulombic efficiency corresponding to the irreversible loss of capacity via direct contact of Pb²⁺ with the Li negative electrode. The expected capacity from a cell without a bipolar faradaic membrane would rapidly fade (as indicated by the dashed line in FIG. 4B and calculated from the observed coulombic efficiency). Instead, the demonstrated capacity showed a much-reduced capacity fade. In addition, Pb droplets were observed to form at the bottom surface of the bipolar faradaic membrane, evidence of the effectiveness of the bipolar faradaic membrane protective charge transfer. While the capacity fade observed (0.2%/cycle) was too high for a long lifetime cell, the mechanism can be optimized to suppress irreversible capacity fade while maximizing round-trip efficiency by tailoring the physical properties (e.g., thickness, electronic conductance, effective porosity) and the materials used for the bipolar faradaic membrane.

### Example 2

A Li—Pb/LiCl—KCl/PbCl₂ displacement cell was assembled with Li—Pb as the negative electrode, Pb as the positive electrode, and LiCl—KCl as the electrolyte. The cell included a bipolar faradaic membrane directly adjacent to the negative electrode, such as shown in FIG. 2. The negative electrode and bipolar faradaic membrane were contained in an electrically conductive container made of a graphite tube. The tube had one-end sealed with 6 g of electronically conductive titanium nitride with 1-2 wt % MgO sintering additive to form the bipolar faradaic membrane. The sintered TiN bottom had pores (about 10 microns in diameter) to allow electrolyte salt permeation but held, and was impermeable to, the liquid negative electrode alloy.

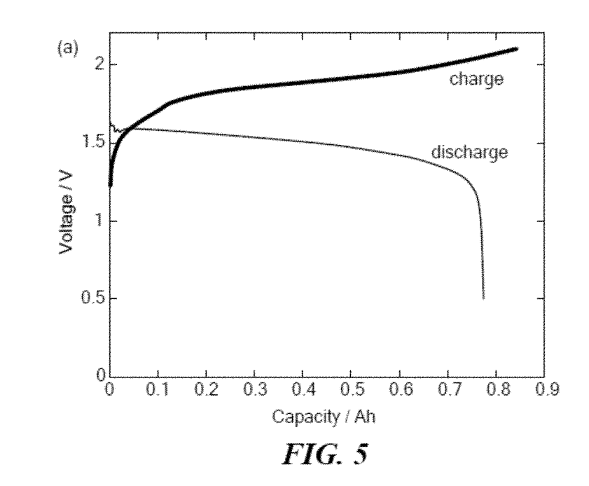

FIG. 5 shows the charge-discharge profiles at an operating temperature of 410° C. having a nominal discharge voltage of about 1.4 V, which is nearly two times that of a prior art liquid metal battery with alloying Li/Pb—Sb cell and 0.4 V lower than the Li/PbCl₂ displacement cell with bipolar faradaic membrane of Example 1. Although the cell voltage is slightly lower than that of a Li/PbCl₂ chemistry, the use of a negative electrode alloy allows for lower operating temperatures without wetting issues (e.g., apparent in the pure Li negative electrode chemistry). The negative electrode alloy, instead of pure Li or Na, lowers the corrosion constraints on secondary components such as seals. After 50 cycles, the negative electrode was removed from the cell, and Pb droplets were observed at the bottom of the porous container. As the density of Pb was higher than that of the electrolyte, Pb continuously dropped back to the positive electrode side, maintaining the cell capacity.

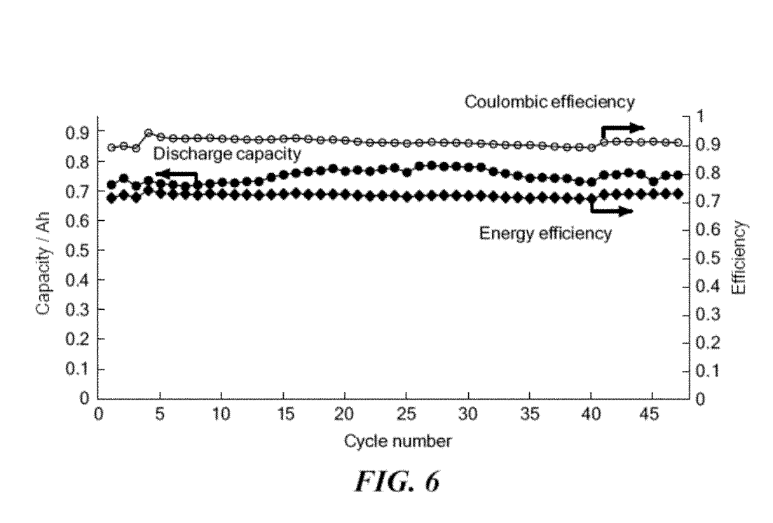

FIG. 6 shows that 50 charge/discharge cycles at a high current density of above 100 mA/cm² was achieved. The cell demonstrated coulombic efficiency higher than 90% and energy efficiency higher than 70%. Importantly, no capacity fade was observed after 50 cycles. Some Pb was consumed and stayed at the bottom of the porous negative electrode. As the amount of Pb at the bottom of the negative electrode was saturated, the Pb began to drop back, keeping the Pb in the positive electrode constant.

### Example 3

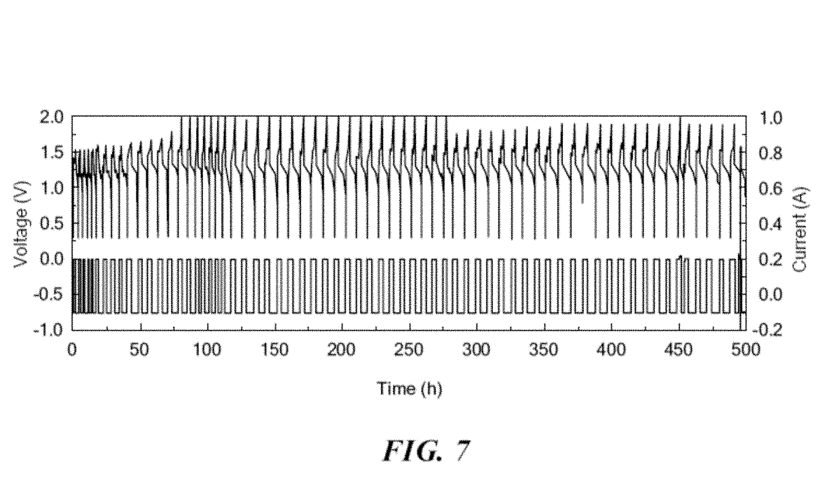

In order to further demonstrate that the configuration was effective at preventing Pb²⁺ permeation, a cell of Li—Bi/LiCl—KCl/PbCl₂ chemistry was assembled to allow for Pb permeation chemical analysis. In this cell, Bi was contained in the porous container as a negative electrode, Pb was employed as the positive electrode, and the LiCl—KCl as the electrolyte. The cell included an electronically conductive titanium nitride faradaic membrane with 1-2 wt % MgO sintering additive (formed according to Example 2) between the Li—Bi negative electrode and the LiCl—KCl electrolyte, such as shown in FIG. 2. After continuous charge-discharge cycles for a week, no Pb was detected by EDS under the detection limits, confirming that the bipolar faradaic membrane with a negative electrode alloy is capable of effectively blocking Pb²⁺. FIG. 7 shows voltage- and current-profiles at an operating temperature of 405° C. As shown, the nominal cell voltage was 1.2V, corresponding to the potential difference of Li—Bi and PbCl₂. The cell was cycled for more than 500 h with coulombic efficiency higher than 92% and energy efficiency higher than 70%. The Li—Bi/PbCl₂ chemistry confirms the versatility of this cell design.

### Example 4

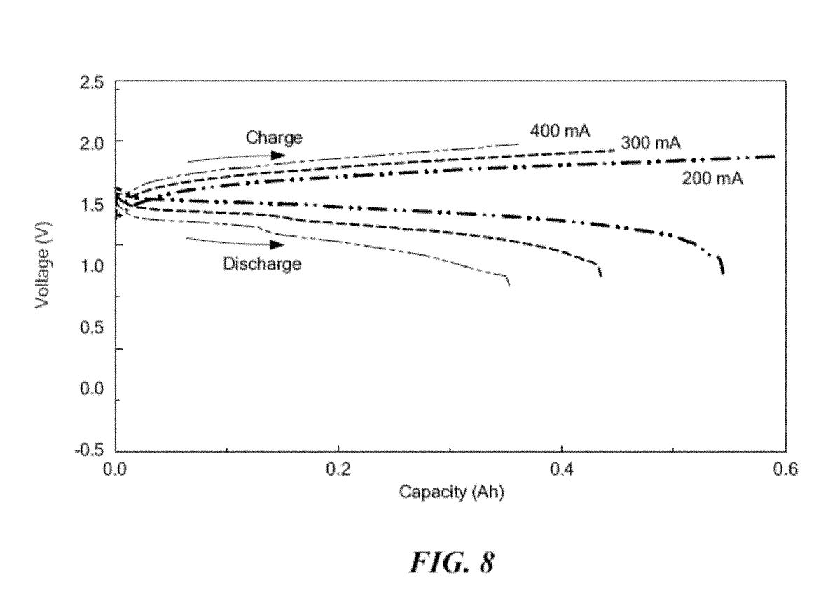

A LiPb/LiCl—KCl/SnCl₂ displacement cell was assembled with Li—Pb as the negative electrode, tin (Sn) as the positive electrode, and LiCl—KCl as the electrolyte. The cell included an electronically conductive titanium nitride faradaic membrane with 1-2 wt % MgO sintering additive (formed according to Example 2) between the Li—Pb negative electrode and the LiCl—KCl electrolyte, such as shown in FIG. 2. FIG. 8 shows voltage profiles at various current densities at an operating temperature of 400° C. As shown, the cell was cycled at various current densities ranging from 200 to 400 mA/cm², and the cell had a coulombic efficiency higher than 90%.

### Example 5

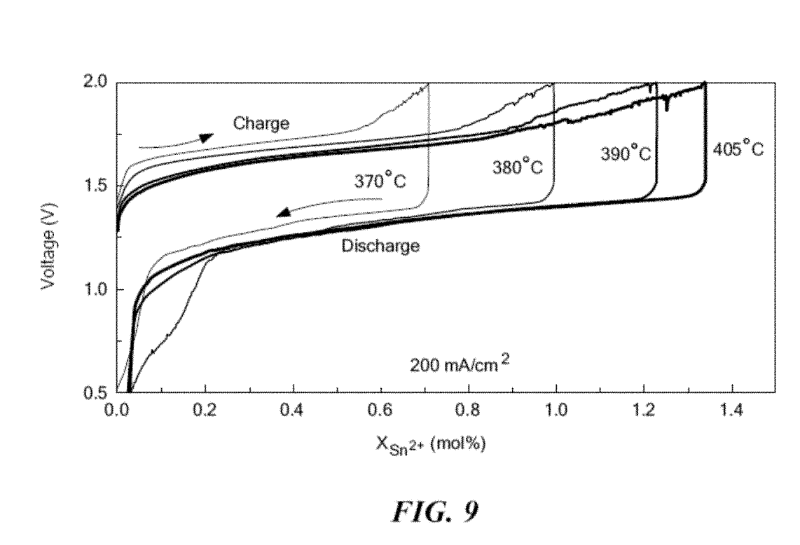

A LiSn/LiCl—KCl/SnCl₂ cell was assembled with Li—Sn as the negative electrode, Sn as the positive electrode, and LiCl—KCl as the electrolyte. The cell included an electronically conductive titanium nitride faradaic membrane with 1-2 wt % MgO sintering additive (formed according to Example 2) between the LiSn negative electrode and the LiCl—KCl electrolyte, such as shown in FIG. 2. FIG. 9 shows voltage profiles at various operating temperatures ranging from 370−405° C. Tin (Sn) and its halides salts (SnCl₂ and SnBr₂) have a low melting temperature, and the Li-Sn∥SnCl₂ chemistry worked at various temperature ranges with a high round-trip efficiency.

### Example 6

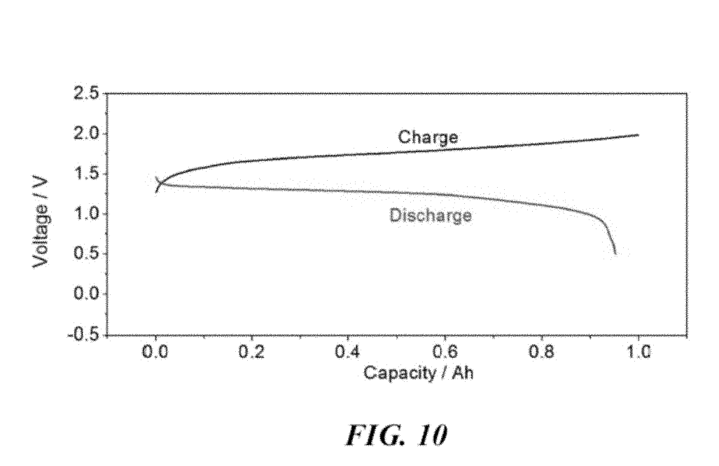

A LiPb/LiBr-KBr/PbBr₂ displacement cell was assembled with Li—Pb as the negative electrode, Pb as the positive electrode, and LiBr—KBr as the electrolyte. The cell included an electronically conductive titanium nitride faradaic membrane with 1-2 wt % MgO sintering additive (formed according to Example 2) between the Li—Pb negative electrode and the bromide electrolyte, such as shown in FIG. 2. The PbBr₂ and bromide based molten salts have lower melting point allowing the cell to operate at a lower temperature. FIG. 10 shows the charge-discharge profiles at an operating temperature of 370° C. As shown, the Li—Pb/PbBr₂ cell had a coulombic efficiency of 95% at 1 Ah scale. The nominal discharge cell voltage was 1.2V at 200 mA/cm².

### Example 7

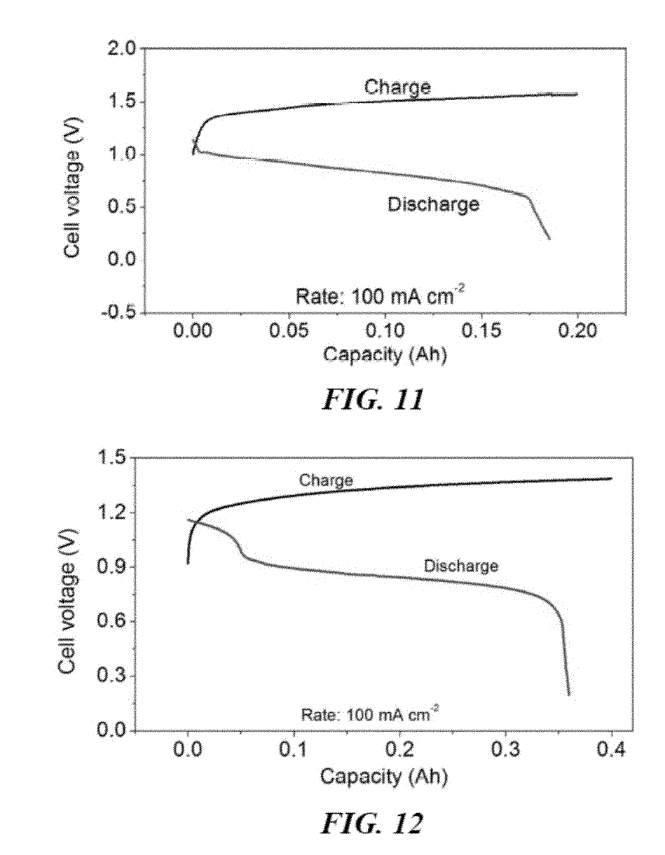

A Mg—Pb/MgCl₂—NaCl—KCl/PbCl₂ displacement cell was assembled with Mg—Pb as the negative electrode, Pb as the positive electrode, and MgCl₂—NaCl—KCl as the electrolyte. The cell included an electronically conductive titanium nitride faradaic membrane with 1-2 wt % MgO sintering additive (formed according to Example 2) between the Mg—Pb negative electrode and the MgCl₂—NaCl—KCl electrolyte, such as shown in FIG. 2. FIG. 11 shows the charge-discharge profiles at an operating temperature of 420° C. As shown, this cell had a coulombic efficiency of 90% and good cyclability.

### Example 8

A Mg—Sn/MgCl₂—NaCl—KCl/PbCl₂ displacement cell was assembled with Mg—Sn as the negative electrode, Pb as the positive electrode, and MgCl₂—NaCl—KCl as the electrolyte. The cell included an electronically conductive titanium nitride faradaic membrane with 1-2 wt % MgO sintering additive (formed according to Example 2) between the Mg—Sn negative electrode and the MgCl₂—NaCl—KCl electrolyte, such as shown in FIG. 2. FIG. 12 shows the charge-discharge profiles at an operating temperature of 420° C. As shown, this cell had a coulombic efficiency of 90% and good cyclability.

### Example 9

As discussed above in paragraph [0029], the anode metal of a displacement cell may be an alloy of Li, the cathode metal may be an alloy of Zn, and the electrolyte may be a mixture of halide salts such as LiCl—KCl. A Li—Al/LiCl—KCl/ZnCl₂ displacement cell was assembled with a LiCl—KCl electrolyte and a negative electrode of pure Al that alloyed with Li, forming Li—Al alloy during charging. The cell was tested with Li concentrations in the Li—Al at ranges of up to about 50 mol %. The ZnCl₂ formed during charging contacted the Zn of the positive electrode. The bipolar faradaic membrane was of porous stainless steel coated with titanium nitride. The membrane pores were about 20 microns in average diameter. The bipolar faradaic membrane was positioned directly adjacent to the negative electrode, as shown in FIG. 2. The negative electrode and bipolar faradaic membrane were contained in an electrically conductive container made of a stainless steel coated with titanium nitride (TiN). The bottom of the membrane had pores (about 20 microns in average diameter) to allow electrolyte salt ion permeation, but was impermeable to uncharged metal atoms. Without wishing to be bound to any particular theory, it is believed that permeation by Zn ions from the positive to the negative electrode was prevented by charge transfer reactions.

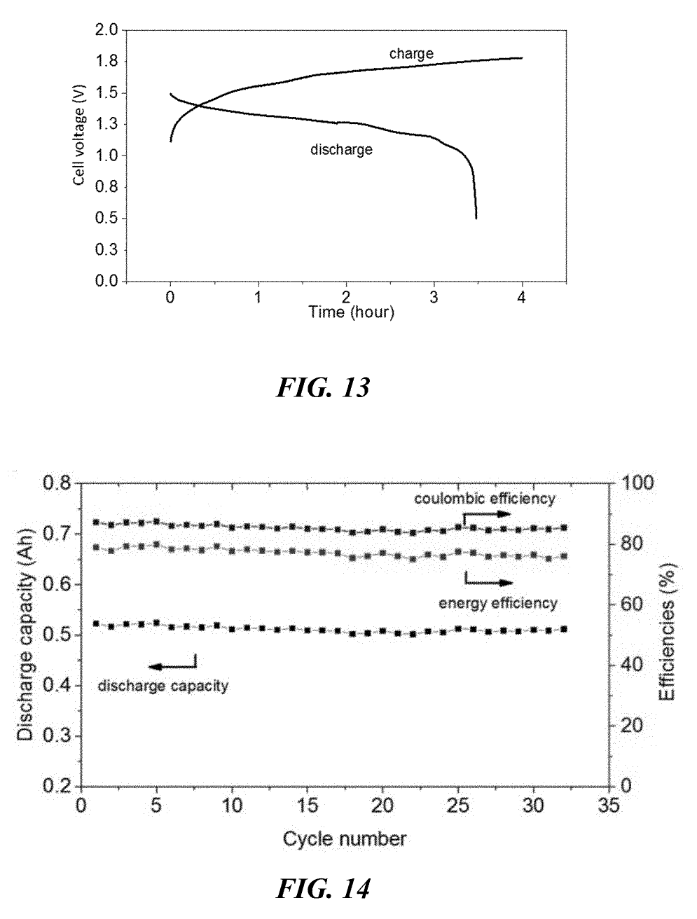

The performance of the cell in terms of cell voltage as a function of time at a charge or discharge current density of 100 mA·cm⁻² and at the operating temperature of 440° C. is illustrated in FIG. 13. The cell was put through a sequence of charge-discharge cycles, and discharge capacity, energy efficiency, and coulombic efficiency were plotted in the graph of FIG. 14. Although the negative electrode was in the solid state all through each charge and discharge cycle, the performance of the cell remained very stable and did not degrade as the cycle index increased.

Although the above discussion discloses various exemplary embodiments of the invention, it should be apparent that those skilled in the art may make various modifications that will achieve some of the advantages of the embodiments without departing from the true scope of the invention.

What is claimed is:

1. An electrochemical cell comprising:
a negative electrode comprising aluminum;
a positive electrode, separate from the negative electrode, comprising a liquid phase having zinc;
a liquid electrolyte, disposed between the negative electrode and the positive electrode, comprising a salt of lithium; and
a bipolar faradaic membrane, disposed between the negative electrode and the positive electrode, having a first surface facing the negative electrode and a second surface facing the positive electrode, wherein:
the bipolar faradaic membrane is configured to allow cations of lithium to pass through and configured to impede cations of zinc from transferring from the second surface to the first surface,
the bipolar faradaic membrane is at least partially formed from a material having an electronic conductivity sufficient to drive faradaic reactions at the second surface with cations of zinc,
when the cell undergoes charging, lithium from the liquid electrolyte alloys with the aluminum of the negative electrode, and a salt of zinc forms on the side of the bipolar faradaic membrane facing the positive electrode.

2. The electrochemical cell according to claim 1, wherein the bipolar faradaic membrane is configured to have the first surface positively charged and the second surface negatively charged.

3. The electrochemical cell according to claim 2, wherein the positively charged first surface and the negatively charged second surface are electrostatically induced.

4. The electrochemical cell according to claim 1, wherein the bipolar faradaic membrane is permeable to a passive spectator ion.

5. The electrochemical cell according to claim 1, wherein the bipolar faradaic membrane comprises an electronic pathway across the bipolar faradaic membrane, wherein the electronic pathway comprises a material selected from the group consisting of iron, steel, and combinations thereof.

6. The electrochemical cell according to claim 1, wherein the bipolar faradaic membrane comprises a material selected from the group consisting of titanium nitride, zirconium nitride, titanium diboride, metals, metalloids, and combinations thereof.

7. The electrochemical cell according to claim 1, wherein the bipolar faradaic membrane comprises a sintering additive, wherein the sintering additive is selected from the group consisting of magnesium oxide, aluminum oxide, aluminum nitride, silicon nitride, silicon oxide, silicon oxynitride, and combinations thereof.

8. The electrochemical cell according to claim 1, wherein the bipolar faradaic membrane is an electronically conductive matrix comprising an insulator and conductive particles, wherein the insulator is selected from the group consisting of magnesium oxide, aluminum oxide, silicon oxide, aluminum nitride, silicon nitride, silicon oxynitride, and/or polymers.

9. The electrochemical cell according to claim 1, wherein the bipolar faradaic membrane comprises a porous stainless steel membrane coated with titanium nitride.

10. The electrochemical cell according to claim 1, wherein the negative electrode further comprises a material selected from the group consisting of sodium, potassium, cesium, magnesium, calcium, strontium, barium, and combinations thereof.

11. The electrochemical cell according to claim 1, wherein the positive electrode further comprises a material selected from the group consisting of lead, tin, bismuth, antimony, mercury, gallium, indium, and combinations thereof.

12. The electrochemical cell according to claim 1, wherein the bipolar faradaic membrane is in direct contact with the negative electrode.

13. The electrochemical cell according to claim 1, wherein the electrolyte is between the negative electrode and the positive electrode, and on the side of the bipolar faradaic membrane facing the positive electrode.

14. The electrochemical cell according to claim 1, wherein the negative electrode is more than 0 mol % and at most 50 mol % in lithium.

15. The electrochemical cell according to claim 1, wherein the electrolyte is selected from the group consisting of LiCl—KCl, LiBr—KBr, and LiCl—LiBr—KBr.

16. An electrochemical cell comprising:
a negative electrode comprising lithium and aluminum;
a positive electrode, separate from the negative electrode, comprising a liquid phase having zinc;
a liquid electrolyte, disposed between the negative electrode and the positive electrode, comprising a salt of lithium and a salt of zinc; and
a bipolar faradaic membrane, disposed between the negative electrode and the positive electrode, having a first surface facing the negative electrode and a second surface facing the positive electrode, wherein:
the bipolar faradaic membrane is configured to allow cations of lithium to pass through and configured to impede cations of zinc from transferring from the second surface to the first surface, and
the bipolar faradaic membrane is at least partially formed from a material having an electronic conductivity sufficient to drive faradaic reactions at the second surface with cations of zinc.

17. The electrochemical cell according to claim 16, wherein the bipolar faradaic membrane comprises a material selected from the group consisting of nickel-iron foam, copper foam, carbon foam, metal felt, metallic fibers, steels, alloys, and combinations thereof.

18. The electrochemical cell according to claim 16, wherein the bipolar faradaic membrane comprises a material selected from the group consisting of copper, titanium, iron, nickel, tungsten, tantalum, molybdenum, silicon, and combinations thereof.

19. The electrochemical cell according to claim 16, wherein a solid or partially solid phase is present in the negative electrode at an operating temperature of the cell.

20. A method of exchanging electrical energy with an external circuit, the method comprising:
connecting an electrochemical cell according to claim 1 to the external circuit; and
operating the external circuit so as to drive transfer of electrons between the negative electrode and the positive electrode.
